(19) United States
(12) Patent Application Publication
(10) Pub. No.: US 2004/0249725 A1
(43) Pub. Date: Dec. 9, 2004

(54) Computerized order processing system and method

(76) Inventors: Sheng Chi Luo, Tu-Chen (TW); Ying Tang, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/860,849

(22) Filed: Jun. 3, 2004

(30) Foreign Application Priority Data
Jun. 3, 2003 (TW) 92115113

(51) Int. Cl. G06F 17/60

(52) U.S. Cl. 705/26

(57) ABSTRACT

A computerized order processing system includes a server (1), a database (3), a plurality of internal user computers (4) and client computers (6), a production operating system (7) and a network (5) interconnecting all the above entities. The server executes various software applications for receiving initial orders and formal orders from the client computers, verifying and modifying the initial orders through any of the internal user computers, and for transmitting verified initial orders, product inventory information, shipping schedules for ordered products and corresponding invoices to the client computers. The server includes an initial order receiving module (20), an initial order verifying module (30), an inventory information transmitting module (40), a formal order receiving module (50), a shipping schedule receiving module (60), a shipping schedule transmitting module (70) and a billing activity management module (80). A related computerized order processing method is also disclosed.

### BACKGROUND OF THE INVENTION

1. Field of the Invention

The present invention relates to order processing systems and methods, and especially to a computerized order processing system and method employing electronic communications.

2. Background of the Invention

Computerized ordering systems and methods are known in the art of automated commercial trade. Numerous schemes have been adopted for order processing. These schemes implement numerous features. The relevant prior art includes the following U.S. patents.

U.S. Pat. No. 5,808,894 issued on Sep. 15, 1998 and entitled Automated Ordering Method discloses a method for automated ordering by a customer at a remote location to a vendor in a central location. The method comprises the steps of composing an order at the remote location and entering the order into a customer computer; initiating a connection between the customer computer and a vendor computer at the central location across a communications media; transmitting the order and customer information identifying the customer to the vendor computer by the customer computer; verifying the order in the vendor computer and transmitting a job number from the vendor computer to the customer computer; comparing the customer information in the vendor computer with previously-stored customer database information; entering the order for further processing in a first manner if the comparing step produces a match between the customer information and the previously-stored customer database information; and entering the order for further processing in a second manner if the comparing step does not produce a match between the customer information and the previously-stored customer database information.

U.S. Pat. No. 6,430,562 issued on Aug. 6, 2002 and entitled Integrated Resource Management System and Method discloses a system and method for communicating between a plurality of disparate hosts and an order processing system. Orders are generated at each of the hosts, and transmitted to a shared message handler. The orders are stored in a relational database table structure using relational database statements. The orders are transmitted from the relational database table structure of the shared message handler to the order processing system. Responses to the orders are received from the order processing system at the shared message handler. Each of the responses is associated with a corresponding order. The statuses of the corresponding orders are updated based on the responses, and then provided to the respective hosts.

Even though there are a variety of features provided by these prior order processing systems, there is room for improvement in the functionality and versatility of such systems. In particular, in these systems, customers simply send their orders to corresponding vendors once only. The customers do not know whether their orders are appropriate according to the vendors' inventory status and production schedules. The vendors cannot automatically determine if they are able to fulfill the customers' orders on time. The vendors accept orders from the customers, and usually make no modifications to the orders according to their inventory status and production schedules. Not surprisingly, it is common for the vendors to be unable to deliver the goods ordered by the customers in time. Therefore, there is a need for providing an improved order processing system and method that can solve the problems described above.

### SUMMARY OF THE INVENTION

The present invention provides a computerized order processing system and method that substantially eliminates or reduce the disadvantages and problems associated with conventional systems and methods.

According to an embodiment of the present invention, a computerized order processing system comprises: a server, a database, a plurality of internal user computers and client computers, a production operating system, and a network interconnecting all the above entities. The server executes various software applications for receiving initial orders and formal orders from the client computers, verifying and modifying the initial orders through any of the internal user computers, and transmitting verified initial orders, product inventory information, shipping schedules for ordered products and corresponding invoices to the client computers. The database stores all information used or generated by the computerized order processing system. Each internal user computer provides an interactive user interface for a operator of a supplier to search, verify and modify customers' orders. Each client computer has an interactive user interface for a customer to submit initial orders and formal orders to the server, and receive verified initial orders, product inventory information, shipping schedules and invoices from the server. The production operating system comprises a production management subsystem and a shipping management subsystem. The production management subsystem controls manufacturing products ordered by the customers, and provides detailed production schedules for scheduling cargo shipment. The shipping management subsystem is provided for scheduling cargo shipment for ordered products according to the formal orders, the product inventory information and production schedules, and for generating corresponding invoices by calculating all charges involved.

The server comprises: an initial order receiving module for obtaining initial orders from client computers; an initial order verifying module for verifying the initial orders according to inventory information on ordered products stored in the database and production schedules obtained from the production operating system, and for transmitting the verified initial orders to the customers via the network; an inventory information transmitting module for transmitting the inventory information on ordered products to the client computers as references for the customers to submit formal orders; a formal order receiving module for receiving the formal orders submitted by the customers; a shipping schedule receiving module for obtaining shipping schedules generated by the shipping management subsystem; a shipping schedule transmitting module for transmitting the shipping schedules to the corresponding client computers; and a billing activity management module for performing necessary billing activities with the customers through the network.

Further, the present invention provides a computerized order processing method comprising the steps of: receiving one or more initial orders from a client computer; verifying said initial orders according to inventory information on ordered products and production schedules; transmitting one or more verified initial orders to the client computer; receiving one or more formal orders from the client computer; receiving one or more shipping schedules and invoices for the ordered products from a production operating system; and transmitting said shipping schedules to the client computer.

Other objects, advantages and novel features of the present invention will be drawn from the following detailed description of a preferred embodiment and preferred method of the present invention with the attached drawings, in which:

### BRIEF DESCRIPTION OF THE DRAWINGS

FIG. 1 is a schematic diagram of hardware configuration of a computerized order processing system in accordance with a preferred embodiment of the present invention;

FIG. 2 is a schematic diagram of function modules of a server of FIG. 1;

FIG. 3 illustrates main data interchanges between entities of the computerized order processing system; and

FIG. 4 is a flowchart of a preferred order processing method by utilizing the computerized order processing system.

### DETAILED DESCRIPTION OF THE INVENTION

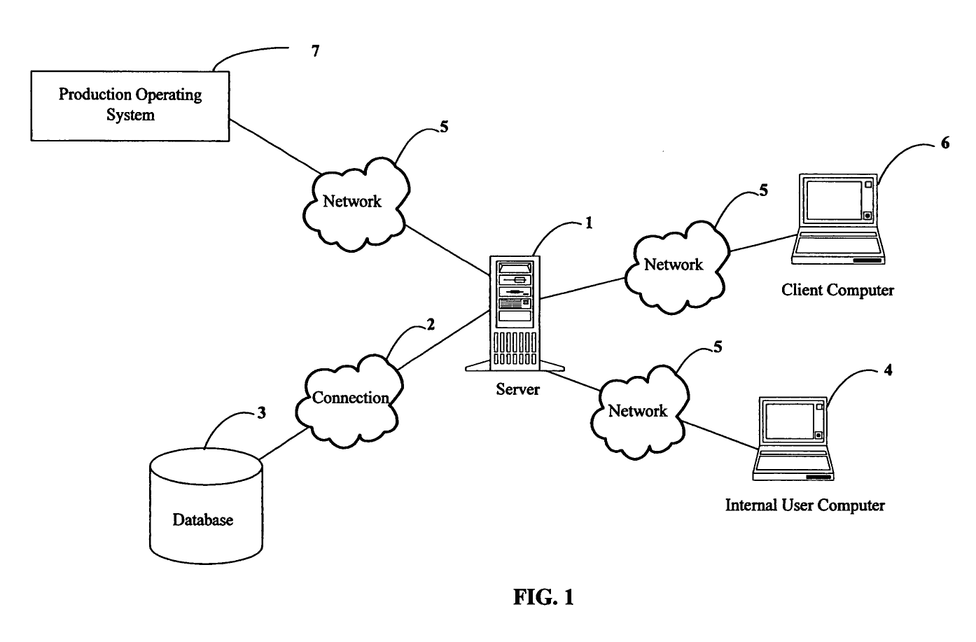

FIG. 1 is a schematic diagram of hardware configuration of a computerized order processing system in accordance with the preferred embodiment of the present invention. The computerized order processing system comprises a server 1, a database 3, a plurality of internal user computers 4 (only one shown) and client computers 6 (only one shown), and a production operating system 7. The server 1 connects with the database 3 via a connection 2, which is a database connectivity such as an Open Database Connectivity (ODBC) and a Java Database Connectivity (JDBC). The server 1, the internal user computers 4, the client computers 6 and the production operating system 7 are interconnected with each other through an electronic communications network 5. The network 5 may for example be an intranet, the Internet, or any other suitable communications link.

The server 1 executes various software applications for receiving initial orders and formal orders from the client computers 6, verifying and modifying the initial orders through any of the internal user computers 4, and transmitting verified initial orders, product inventory information, shipping schedules for ordered products and corresponding invoices to the client computers 6. The database 3 stores all information used or generated by the computerized order processing system. Such information comprises initial orders and formal orders submitted by customers, product inventory information, shipping schedules, and invoices. Each internal user computer 4 provides an interactive user interface for internal operators of a supplier to search, verify and modify customers' orders. Each client computer 6 also has an interactive user interface for a customer to perform operations of submitting initial orders and formal orders to the server 1, and of receiving verified initial orders, product inventory information, shipping schedules and invoices from the server 1. The production operating system 7 comprises a production management subsystem, and a shipping management subsystem (not shown). The production management subsystem controls manufacturing of products ordered by the customers, and provides detailed production schedules for scheduling cargo shipment. The shipping management subsystem is provided for scheduling cargo shipment for ordered products according to the formal orders, the product inventory information and production schedules, and for generating corresponding invoices by calculating all charges involved.

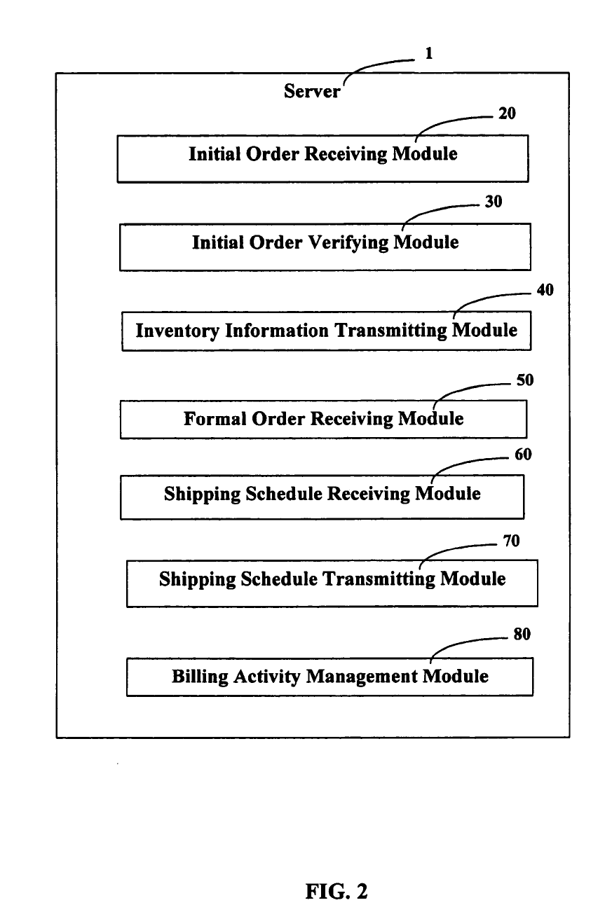

FIG. 2 shows all function modules comprised in the server 1 according to the present invention. The server 1 comprises an initial order receiving module 20, an initial order verifying module 30, an inventory information transmitting module 40, a formal order receiving module 50, a shipping schedule receiving module 60, a shipping schedule transmitting module 70, and a billing activity management module 80.

The initial order receiving module 20 is provided for obtaining initial orders submitted by customers via the client computers 6. The initial order verifying module 30 is provided for verifying the initial orders according to inventory information on ordered products stored in the database 3 and production schedules obtained from the production operating system 7, and for transmitting the verified initial orders to the customers via the network 5. In some cases, operators of the supplier need to make modifications to the initial orders in view of the information obtained through the initial order verifying module 30. The inventory information transmitting module 40 provides corresponding client computers 6 with the inventory information on ordered products as references for the customers to submit formal orders. The formal order receiving module 50 receives the formal orders submitted by the customers. When shipping schedules are generated in the shipping management subsystem according to the formal orders, the inventory information and production schedules, the shipping schedule receiving module 60 obtains the shipping schedules. The shipping schedule transmitting module 70 transmits the shipping schedules to the corresponding client computers 6. The billing activity management module 80 is used for performing necessary billing activities with the customers through the network 5.

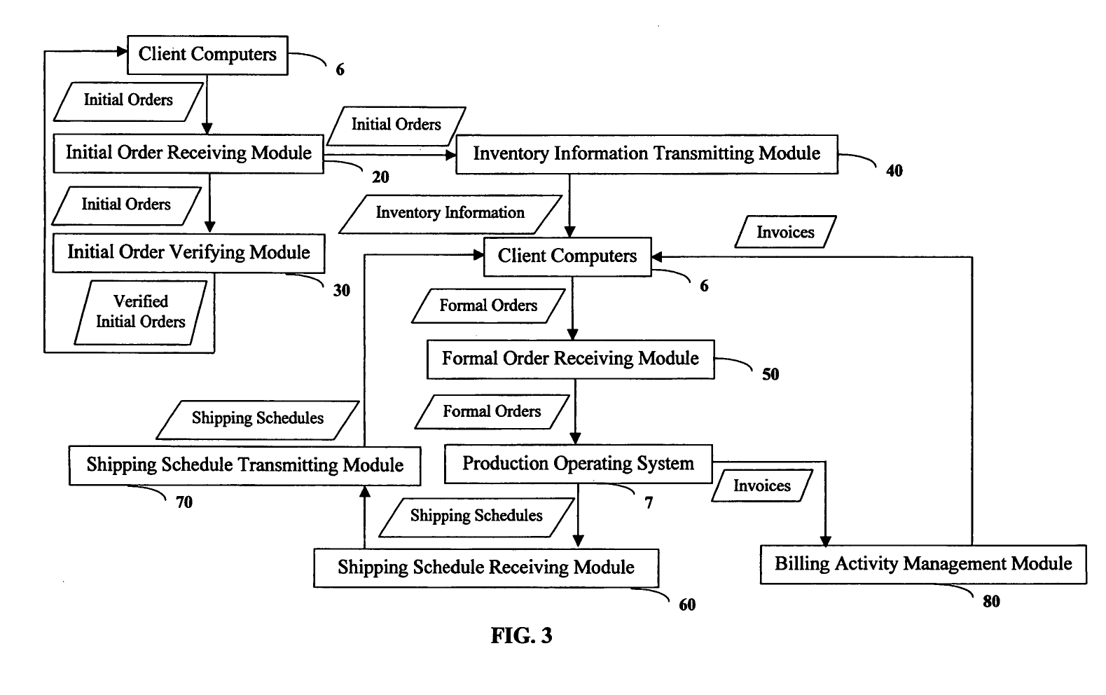

FIG. 3 illustrates main data interchanges between the function modules of the server 1, the client computers 6 and the production operating system 7. First, initial orders are generated in the client computers 6, and received by the initial order receiving module 20. The initial orders are then shared by the initial order verifying module 30 and the inventory information transmitting module 40. The initial order verifying module 30 verifies the initial orders, and generates verified initial orders. The verified initial orders are then transmitted to the client computers 6. The inventory information transmitting module 40 transmits inventory information on ordered products to the client computers 6. The customers then submit formal orders to the supplier according to the verified initial orders and the inventory information. The formal orders are received by the formal order receiving module 50, and transmitted to the production operating system 7. Thereafter, shipping schedules and corresponding invoices are generated by the shipping management subsystem. The shipping schedules are received by the shipping schedule receiving module 60, and then transmitted to the client computers 6 by the shipping schedule transmitting module 70. The invoices are obtained by the billing activity management module 80, and then transmitted by the billing activity management module 80 to the client computers 6.

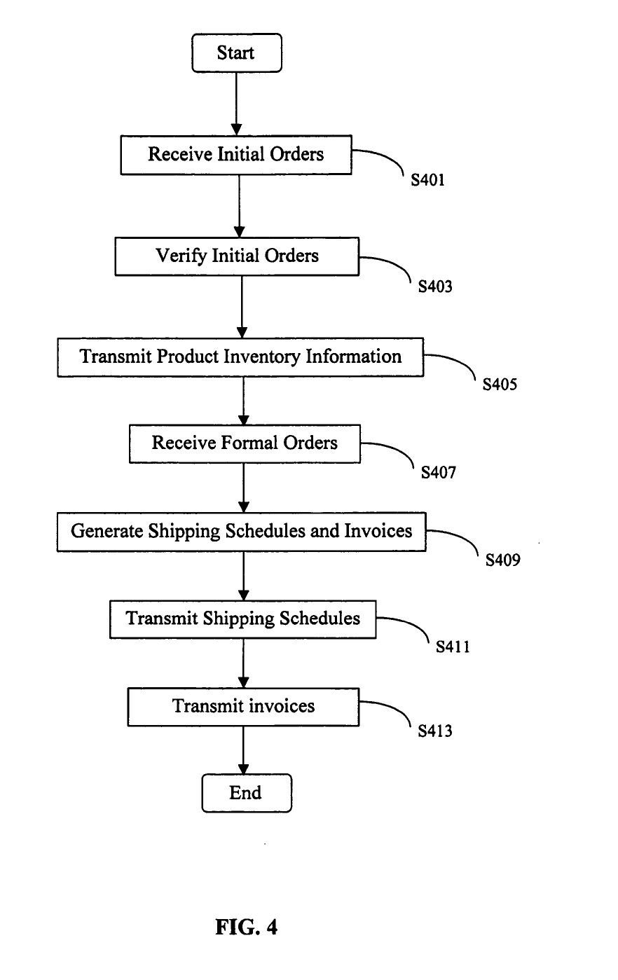

FIG. 4 is a flowchart of a preferred order processing method in accordance with the present invention. In step S401, the initial order receiving module 20 receives initial orders from any one of the client computers 6. In step S403, the initial order verifying module 30 verifies the initial orders according to current inventory information on ordered products, and makes modifications to the initial orders if necessary. The verified initial orders are then transmitted to the client computer 6. In step S405, the inventory information transmitting module 40 transmits inventory information on the ordered products to the client computer 6. In step S407, the client computer 6 generates formal orders according to the verified initial orders and inventory information. The formal orders are submitted to the server 1, and received by the formal order receiving module 50. In step S409, the shipping management subsystem obtains the formal orders and current inventory information on ordered products from the server 1, and obtains production schedules from the production management subsystem. Shipping schedules for ordered products and corresponding invoices are generated by the shipping management subsystem according to the above obtained information. In step S411, the shipping schedules are obtained by the shipping schedule receiving module 60, and transmitted to the client computer 6. In step S413, the invoices are obtained by the billing activity management module 80, and transmitted to the client computer 6.

Although the present invention has been specifically described on the basis of a preferred embodiment and preferred method, the invention is not to be construed as being limited thereto. Various changes or modifications may be made to said embodiment and method without departing from the scope and spirit of the invention.

What is claimed is:

1. A computerized order processing system comprising:
a database for storing all information used or generated by the computerized order processing system;
a plurality of client computers, each of the client computers providing an interactive user interface for a customer to submit initial orders and formal orders to a supplier, and receive verified initial orders, product inventory information, shipping schedules and invoices from the supplier; and
a server comprising:
an initial order receiving module obtaining initial orders from the client computers;
an initial order verifying module for verifying the initial orders according to inventory information on ordered products;
an inventory information transmitting module for transmitting product inventory information to the client computers;
a formal order receiving module for receiving formal orders submitted by the client computers;
a shipping schedule receiving module for obtaining shipping schedules for ordered products; and
a shipping schedule transmitting module for transmitting the shipping schedules to the client computers.

2. The computerized order processing system according to claim 1, wherein the server further comprises a billing activity management module for performing billing activities with customers.

3. The computerized order processing system according to claim 1, further comprising a plurality of internal user computers, each of the internal user computers providing an interactive user interface for an operator of a supplier to search, verify and modify customers' orders.

4. The computerized order processing system according to claim 1, further comprising a production operating system, the production operating system comprising:
a production management subsystem for controlling manufacturing of products ordered by customers, and for providing production schedules for scheduling cargo shipment; and
a shipping management subsystem for scheduling cargo shipment for ordered products according to formal orders, product inventory information and production schedules, and for generating corresponding invoices by calculating all charges involved.

5. A computerized order processing method comprising the steps of:
receiving one or more initial orders from a client computer;
verifying said initial orders according to inventory information on ordered products and production schedules;
transmitting one or more verified initial orders to the client computer;
receiving one or more formal orders from the client computer;
receiving one or more shipping schedules and invoices for the ordered products from a production operating system; and
transmitting said shipping schedules to the client computer.

6. The computerized order processing method according to claim 1, further comprising the step of transmitting product inventory information to the client computer.

7. The computerized order processing method according to claim 1, further comprising the step of transmitting said invoices to the client computer.
